(19) United States
(12) Patent Application Publication
(10) Pub. No.: US 2021/0053146 A1
(43) Pub. Date: Feb. 25, 2021

(54) APPARATUS FOR AND A METHOD OF KEYHOLE FREE FRICTION STIR SPOT WELDING

(71) Applicant: Ozyegin Universitesi, Istanbul (TR)

(72) Inventors: Guney Guven Yapici, Istanbul (TR); Isam Jabbar Ibrahim Bajilane, Istanbul (TR)

(21) Appl. No.: 16/549,653

(22) Filed: Aug. 23, 2019

(51) Int. Cl. B23K 20/12; B21D 39/03

(52) U.S. Cl. CPC B23K 20/1245; B21D 39/03

(57) ABSTRACT

Embodiments of the present invention relates to an apparatus (1) for friction stir spot welding and a method of friction stir spot welding providing a keyhole free welding. The method comprises placing an intermediate piece (5) between at least one first workpiece (3) and at least one second workpiece (4) for forming a sandwich structure (S); pressing the sandwich structure (S) such that the intermediate piece (5) is trapped between the second workpiece (4) and an embossing (E) formed on the first workpiece (3); pressing the embossing (E) by a rotating tool comprising a substantially flat end (6.1) for pressing so as to plasticize the intermediate piece (5), at least one part of each of the first workpiece (3) and the second workpiece (4).

### FIELD OF THE INVENTION

The present invention relates to an apparatus for friction stir spot welding and a method of friction stir spot welding providing a keyhole free welding.

### BACKGROUND OF THE INVENTION

Friction stir welding FSW is a solid-state joining process employing a non-consumable tool to combine two workpieces having adjacent contacting surfaces by heating below melting point of the workpiece materials. The heat is generated by friction between a tapered pin of a rotating tool of welding apparatus and the workpieces. The generated heat leads to plasticization of the work piece materials in a region near the pin.

Friction stir spot welding FSSW is a variant of the FSW where welding is practiced on a point of the workpiece surfaces. In FSSW, two workpieces one on top of the other are disposed on an anvil. A spot weld is created by pressing a rotating tool with high force onto the top surface of overlapping workpieces abutting on the anvil. The frictional heat due to rotation and the high pressure plasticize the workpiece material in the spot, so that a tapered pin of the rotating tool penetrates into a spot (region to be welded) between the two workpieces. The tapered pin of the rotating tool is plunged into the workpieces until a shoulder surrounding the rotating tool is in contact with the surface of the top workpiece. Rotation of the rotating tool also mixes the plasticized materials of workpieces. The shoulder restrains the plasticized materials and the rotating tool applies a high forging pressure, which bonds the workpieces without melting the workpiece material. Finally, the rotating tool is pulled out of the workpieces to emerge spot weld having a weld nugget in form of a valley.

After pulling out the rotary tool, a keyhole (i.e., an exit hole arising from the penetrated volume of the pin when the rotating tool is retracted) is left in the welded workpieces. The keyhole may be filled with an appropriate material with a post processing or using a consumable pin. The post processing and/or using a using consumable pins increase the final cost of the production. Moreover, the filler may break undesirably from the keyhole due to the stress difference between the filler and the workpieces. Another problem of FSSW with keyhole in the state of the art is that since the FSSW provides a relatively less flexible weld, the keyholes constitute a weak point for the weld. Yet another problem of FSSW in the state of the art is that since the pin of the rotating tool must penetrate into workpieces in a certain minimum depth, workpieces having a total wall thickness lower than the certain minimum depth cannot be welded by FSSW. Yet another problem of FSSW in the state of the art is that if pin of the rotating tool is not long enough, then the rotating tool may not penetrate enough into the workpiece close to the anvil. Thus, the said workpiece may not be plasticized and forged by the rotating tool. This lack of penetration can cause defects in the weld which is a potential source of fatigue cracks.

Consequently, there is a need in the state of the art for an apparatus for and a method of FSSW providing a keyhole free welding.

### BRIEF DESCRIPTION OF THE DRAWINGS

An exemplary embodiment of the present invention is illustrated by way of example in the accompanying drawings to be more easily understood and uses thereof will be clearer when considered in view of the detailed description, in which like reference numbers indicate the same or similar elements, and the following figures in which:

FIG. 1 shows schematic views of the apparatus for friction stir spot welding (without shoulder) comprising a press head during welding stages in one exemplary embodiment of the present invention.

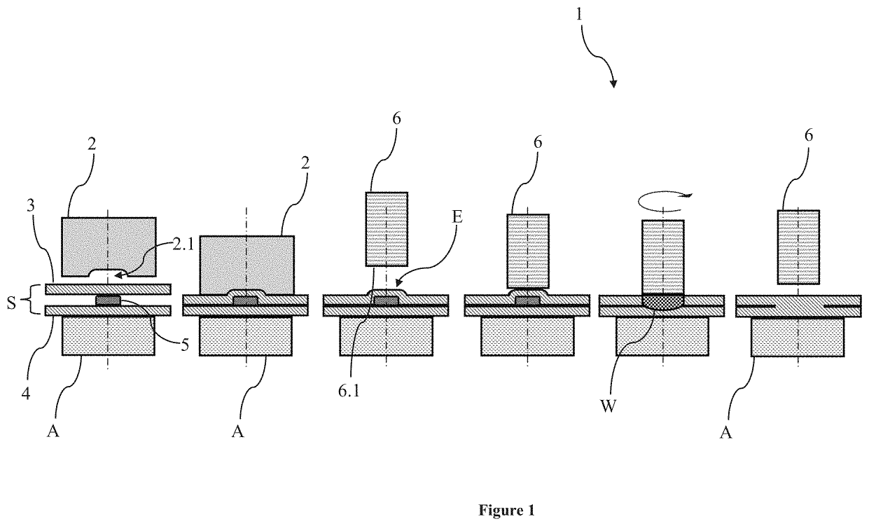

FIG. 2 shows schematic views of apparatus for friction stir spot welding comprising a press head in the form of a shoulder during welding stages in one exemplary embodiment of the present invention.

FIG. 3 is schematic views of apparatus for friction stir spot welding comprising a press head and a forging shoulder (different from press head) during welding stages in one exemplary embodiment of the present invention.

The elements illustrated in the figures are numbered as follows:
1. Apparatus
2. Press head
   2.1. Cavity
   2.2. Space
3. First workpiece
4. Second workpiece
5. Intermediate piece
6. Rotary tool
   6.1. Substantially flat end
7. Shoulder
8. Forging shoulder
   8.1. Recess
S. Sandwich structure
A. Anvil
E. Embossing
W. Weld nugget

### DETAILED DESCRIPTION

Embodiments of the present invention relates to an apparatus (1) for and a method of friction stir spot welding.

The apparatus (1) for friction stir spot welding comprises;
a press head (2) having a body wherein the body comprising a cavity (2.1) for receiving an intermediate piece (5) and one part of at least one first workpiece (3) adjacent to the intermediate piece (5);
a rotary tool (6) comprising a substantially flat end (6.1) for pressing.

The press head (2) and the rotary tool (6) are configured for coupling with at least one pressing means.

The press head (2) is for pressing a sandwich structure (S) comprising the intermediate piece (5) positioned between the at least one first workpiece (3) and at least one second workpiece (4) against an anvil (A) such that the intermediate piece (5) is trapped between the second workpiece (4) and an embossing (E) formed on the first workpiece (3) when the press head (2) applies pressure.

The rotary tool (6) is for pressing the embossing (E) via the substantially flat end (6.1) while rotating so as to plasticize the intermediate piece (5), at least one part of each of the first workpiece (3) and the second workpiece (4).

Working principle of one embodiment of the apparatus (1) is described in detail below.

A sandwich structure (S) comprising the intermediate piece (5) disposed/positioned between the at least one first workpiece (3) and at least one second workpiece (4) is placed on an anvil (A). The press head (2) presses the sandwich structure (S) against the anvil (A). The end of the press head (2) having the cavity (2.1) pushes surface of the first workpiece (3). Since the intermediate piece (5) and a part/region of the first workpiece (3) adjacent to the intermediate piece (5) (in other words the first workpiece (3) partly covering the intermediate piece (5)) are received into the cavity (2.1), pressure of the press head (2) is not applied to them. Other regions of the first workpiece (3) around vicinity of the intermediate piece (5) are pushed through the second workpiece (4) by the press head (2) through edge of the cavity (2.1). Thus, the intermediate piece (5) and region of the first workpiece (3) adjacent to the intermediate piece (5) (partly covering the intermediate piece (5)) form an embossing (E) on the first workpiece (3).

Then, while spinning, the rotary tool (6) presses the embossing (E) by its substantially flat end (6.1). The substantially flat end (6.1) of the rotary tool (6) pushes the embossing (E) against the second workpiece (4) and the anvil (A) such that the intermediate piece (5), at least one part of the first workpiece (3) and at least one part of the second workpiece (4) are plasticized. Furthermore, due to the rotational motion of the substantially flat end (6.1), the plasticized materials are mixed. Since the pressing end of the rotary tool (6) facing the first workpiece (3) is substantially flat, the pressing flat end (substantially flat end (6.1)) does not penetrate into the first workpiece (3)/the embossing (E). Instead, the substantially flat end (6.1) also applies a forging pressure to plasticize materials and forms a flat weld nugget (W) without a keyhole.

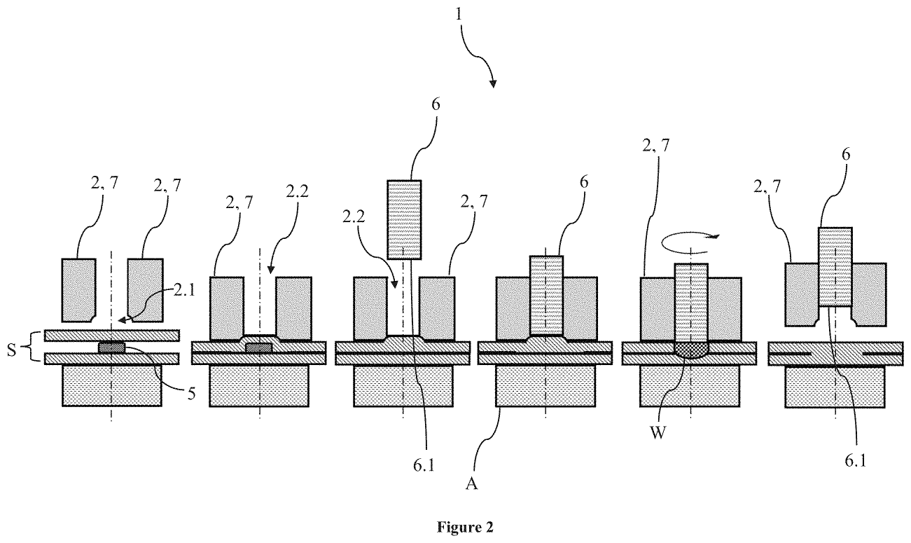

In one embodiment of the apparatus (1) (see FIG. 2), the press head (2) is a shoulder (7) wherein a space (2.2) for receiving the rotary tool (6) is provided (inside the body) through at least one part of the body. The press head (2)/shoulder (7) is for pressing the peripheral of the embossing (E) to the second workpiece (4) and the anvil (A). The cavity (2.1) restrains the plasticized intermediate piece (5), (plasticized) parts of the first workpiece (3) and the second workpiece (4), which constitute the weld nugget (W), during the pressing of the embossing (E).

In this embodiment of the apparatus (1), press head (2) in the form of shoulder (7) guarantees to apply the forging pressure to plasticize materials (weld nugget (W)) by restraining the plasticized materials to be flat. The restraining is to keep the plasticized material between the second workpiece (4) and substantially flat end (6.1) of the rotary tool (6). Moreover, the pressure of the press head (2) provides a clamping effect to prevent the relative movement of the first workpiece (3) and second workpiece (4) during the pressing the embossing (E)/plasticization of the material. In this embodiment, the rotary tool (6) must be movable independently from the shoulder (7).

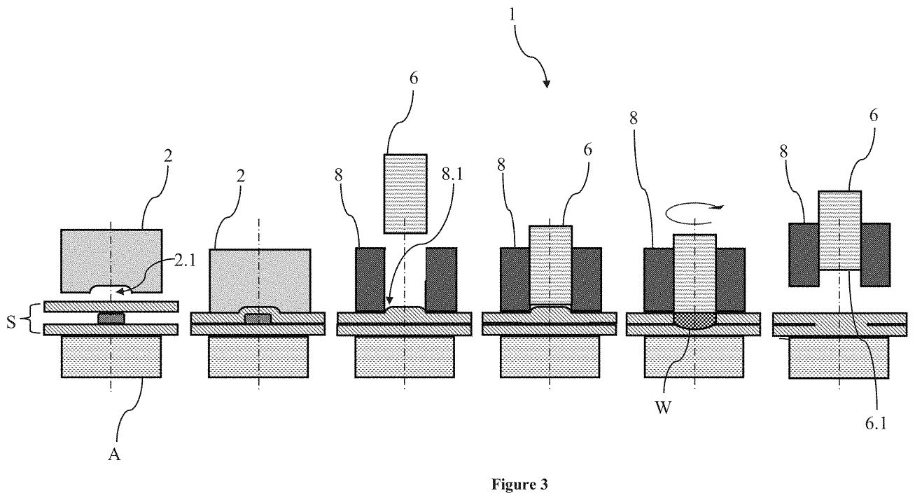

In another embodiment of the apparatus (1) (see FIG. 3), the apparatus (1) comprises a forging shoulder (8) which is a different part from the press head (2). The forging shoulder (8) surrounds the rotary tool (6) and for pressing the peripheral of the embossing (E) to the second workpiece (4) and the anvil (A). Thus, the forging shoulder (8) is configured for coupling with at least one pressing means. In this embodiment, one end of the forging shoulder (8) for facing the embossing (E) comprises a recess (8.1). The recess (8.1) is for receiving the intermediate piece (5) one part of the first workpiece (3) adjacent to the intermediate piece (5) (in other words the first workpiece (3) partly covering the intermediate piece (5)) and for restraining the plasticized intermediate piece (5), (plasticized) parts of the first workpiece (3) and the second workpiece (4) during the pressing of the embossing (E). The restraining is to keep the plasticized material between the second workpiece (4) and substantially flat end (6.1) of the rotary tool (6). In this embodiment, the forging shoulder (8) is movable independently from the rotary tool (6). Moreover, the pressure of the forging shoulder (8) provides a clamping effect to prevent the relative movement of the first workpiece (3) and second workpiece (4) during the pressing the embossing (E)/plasticization of the material.

One important difference between the press head (2) in the form of shoulder (7) and the forging shoulder (8) is shape and/or size difference between the cavity (2.1) and recess (8.1). In some applications, appropriate shape/size of the cavity (2.1) for pressing a sandwich structure (S) may be substantially different than appropriate shape/size of the recess (8.1) for forging the plasticized materials to adjust the forging pressure for enhancing the weld. Thus, a press head (2) is used for pressing the sandwich structure (S) and forming the embossing (E). Then, a forging shoulder (8) may be used for forging the plasticized materials. In some applications, press head (2) in the form of shoulder (7) may be used both for pressing the sandwich structure (S) and forming the embossing (E), and for forging the plasticized materials.

The intermediate piece (5) may comprise a same material as or different than the material of the first workpiece (3) or second workpiece (4). The intermediate piece (5) and/or the first workpiece (3) and/or second workpiece (4) may be, for example, but not limited to, metals, polymers, metal matrix composites, polymer matrix composites.

A method of friction stir spot welding comprises following steps;
a) placing an intermediate piece (5) between at least one first workpiece (3) and at least one second workpiece (4) for forming a sandwich structure (S);
b) pressing the sandwich structure (S) such that the intermediate piece (5) is trapped between the second workpiece (4) and an embossing (E) formed on the first workpiece (3);
c) pressing the embossing (E) by a rotating tool comprising a substantially flat end (6.1) so as to plasticize the intermediate piece (5), at least one part of each of the first workpiece (3) and the second workpiece (4).

In one embodiment of the method, in above step b) the sandwich structure (S) is pressed by a press head (2) having a body wherein the body comprising a cavity (2.1) for receiving at least one part of the intermediate piece (5) and the first workpiece (3) such that the intermediate piece (5) is trapped between the second workpiece (4) and the embossing (E) formed on the first workpiece (3).

In another embodiment of the method, the method comprises following step;
d) pressing peripheral of the embossing (E) by a forging shoulder (8) surrounding the rotating tool and comprising a recess (8.1) such that the forging shoulder (8) restrains the plasticized first workpiece (3), intermediate piece (5) and second workpiece (4).

In another embodiment of the method, the press head (2) is a shoulder (7) wherein a space (2.2) for receiving the rotary tool (6) is provided (inside the body) through at least one part of the body wherein the cavity (2.1) forges the plasticized first workpiece (3), intermediate piece (5) and second workpiece (4) by guiding during the step c).

1. An apparatus (1) for friction stir spot welding comprising;
a press head (2) having a body wherein the body comprising a cavity (2.1) for receiving an intermediate piece (5) and one part of at least one first workpiece (3) adjacent to the intermediate piece (5);
a rotary tool (6) comprising a substantially flat end (6.1) for pressing;
wherein the press head (2) and the rotary tool (6) are configured for coupling with at least one pressing means;
wherein the press head (2) is for pressing a sandwich structure (S) comprising the intermediate piece (5) positioned between the at least one first workpiece (3) and at least one second workpiece (4) against an anvil (A) such that the intermediate piece (5) is trapped between the second workpiece (4) and an embossing (E) formed on the first workpiece (3) when the press head (2) applies pressure,
wherein the rotary tool (6) is for pressing the embossing (E) via the substantially flat end (6.1) while rotating so as to plasticize the intermediate piece (5), at least one part of each of the first workpiece (3) and the second workpiece (4).

2. The apparatus (1) according to claim 1 wherein the press head (2) is a shoulder (7) wherein a space (2.2) for receiving the rotary tool (6) is provided through at least one part of the body wherein the cavity (2.1) restrains the plasticized intermediate piece (5), parts of the first workpiece (3) and the second workpiece (4) during the pressing of the embossing (E).

3. The apparatus (1) according to claim 1 comprising a forging shoulder (8) surrounding the rotary tool (6) and for pressing the peripheral of the embossing (E) wherein the forging shoulder (8) comprises a recess (8.1) for restraining the plasticized first workpiece (3), intermediate piece (5) and second workpiece (4) during the pressing of the embossing (E).

4. A method of friction stir spot welding comprising following steps;
a) placing an intermediate piece (5) between at least one first workpiece (3) and at least one second workpiece (4) for forming a sandwich structure (S);
b) pressing the sandwich structure (S) such that the intermediate piece (5) is trapped between the second workpiece (4) and an embossing (E) formed on the first workpiece (3);
c) pressing the embossing (E) by a rotating tool comprising a substantially flat end (6.1) so as to plasticize the intermediate piece (5), at least one part of each of the first workpiece (3) and the second workpiece (4).

5. The method according to claim 4 wherein in step b) the sandwich structure (S) is pressed by a press head (2) having a body wherein the body comprising a cavity (2.1) for receiving at least one part of the intermediate piece (5) and the first workpiece (3) such that the intermediate piece (5) is trapped between the second workpiece (4) and the embossing (E) formed on the first workpiece (3).

6. The method according to claim 4 comprising;
d) pressing peripheral of the embossing (E) by a forging shoulder (8) surrounding the rotating tool and comprising a recess (8.1) such that the forging shoulder (8) restrains the plasticized first workpiece (3), intermediate piece (5) and second workpiece (4).

7. The method according to claim 5 wherein the press head (2) is a shoulder (7) wherein a space (2.2) for receiving the rotary tool (6) is provided through at least one part of the body wherein the cavity (2.1) restrains the plasticized first workpiece (3), intermediate piece (5) and second workpiece (4) by guiding during the step c).
